(19) United States
(12) Patent Application Publication
(10) Pub. No.: US 2022/0064504 A1
(43) Pub. Date: Mar. 3, 2022

(54) AQUEOUS ADHESIVE COMPOSITION

(71) Applicant: 3M INNOVATIVE PROPERTIES COMPANY, St Paul, MN (US)

(72) Inventors: Jun Fujita, Tokyo (JP); Takayuki Kojima, Tokyo (JP)

(21) Appl. No.: 17/417,242

(22) PCT Filed: Dec. 23, 2019
(86) PCT No.: PCT/IB2019/061290

§ 371 Date: Jun. 22, 2021

(30) Foreign Application Priority Data
Dec. 25, 2018 (JP) 2018-241852

(51) Int. Cl. C09J 133/08; C09J 133/12; C09J 123/28; C08F 220/18; C08F 220/14; C08F 220/20; C08F 220/06; C08F 220/56; C08F 222/10; C08F 2/18; C08F 2/20

(52) U.S. Cl. CPC C09J 133/08; C09J 133/12; C09J 123/28; C08F 220/1808; C08F 220/1804; C08F 220/1806; C09J 2423/006; C08F 220/20; C08F 220/06; C08F 220/56; C08F 222/102; C08F 2/18; C08F 2/20; C08F 220/14

(57) ABSTRACT

An aqueous adhesive composition in an embodiment of the present disclosure includes a particulate polymer containing a (meth)acrylate polymer and a chlorinated polyolefin.

### TECHNICAL FIELD

The present disclosure is related to an aqueous adhesive composition.

### BACKGROUND ART

Solvent type adhesives usually include volatile chemical substances harmful to a human body, such as toluene and aldehyde. Therefore, the volatile chemical substances may scatter or these chemical substances may be volatilized from products produced by using solvent type adhesives and may adversely affect a human body at an operation site where, for example, spray coating is performed. Consequently, aqueous adhesives have been used more frequently instead of solvent type adhesives in recent years.

Patent Literature 1 (JP 01-024875 A) describes an aqueous adhesive composition including an aqueous emulsion, a styrene-butadiene copolymer latex compound containing a tackifying resin, a chlorinated polyolefin dissolved in toluene, and a rosin-based aqueous emulsion type adhesive in prescribed amounts.

Patent Literature 2 (JP 2011-01444 A) describes an aqueous adhesive composition including an acid modified polyolefin-based resin and a core-shell type curing agent.

### PATENT LITERATURE

Patent Literature 1: JP 01-024875 A

Patent Literature 2: JP 2011-01444 A

### SUMMARY OF INVENTION

Aqueous adhesives are more excellent than solvent type adhesives in improving operation environment or the like but may be poorer than solvent type adhesives in adhesiveness to base materials.

The present disclosure provides an aqueous adhesive composition having excellent adhesiveness.

### SOLUTION TO PROBLEM

An embodiment of the present disclosure provides an aqueous adhesive composition including a particulate polymer containing a (meth)acrylate polymer and a chlorinated polyolefin.

Another embodiment of the present disclosure provides a method for producing an aqueous adhesive composition containing a particulate polymer, the method including the steps of: compounding a chlorinated polyolefin in a (meth)acrylate monomer to prepare a solution, mixing and suspending the solution and water containing a surfactant to prepare a suspension including droplets incorporating the (meth)acrylate monomer and a dissolved chlorinated polyolefin, and compounding an oil soluble polymerization initiator in the suspension and then polymerizing the (meth)acrylate monomer to prepare a particulate polymer containing a (meth)acrylate polymer and a chlorinated polyolefin.

### Advantageous Effect of Invention

The present disclosure can provide an aqueous adhesive composition having excellent adhesiveness, particularly, to a polyolefin member.

The above description shall not be deemed to include all of the embodiments of the present invention and all of the advantages of the present invention.

### BRIEF DESCRIPTION OF DRAWINGS

FIG. 1A is a schematic view of an aqueous adhesive composition according to an embodiment of the present disclosure. FIG. 1B is a schematic view of an aqueous adhesive composition including (meth)acrylate polymer particles and solid-state chlorinated polyolefin particles.

### DESCRIPTION OF EMBODIMENTS

An aqueous adhesive composition in a first embodiment of the present disclosure includes a particulate polymer containing a (meth)acrylate polymer and a chlorinated polyolefin. Without being limited to the following principle, the present inventors believe that the chlorinated polyolefin in the particulate polymer is present in a dissolved state. As a result, it is believed that since this chlorinated polyolefin can better spread than a solid-state chlorinated polyolefin, adhesive strength, particularly, adhesive strength to a polyolefin member can be improved.

The (meth)acrylate polymer of the aqueous adhesive composition in the first embodiment of the present disclosure can be obtained from a material including an alkyl (meth)acrylate including an alkyl group having from 1 to 18 carbons, an unsaturated monomer including a polar group, and an oil soluble polymerization initiator.

An alkyl (meth)acrylate having Tg of a homopolymer being 20° C. or more and an alkyl (meth)acrylate being other than this alkyl (meth)acrylate and including an alkyl group having from 4 to 18 carbons can be used as the alkyl (meth)acrylate in the material used to form the (meth)acrylate polymer of the aqueous adhesive composition in the first embodiment of the present disclosure.

The material used to form the (meth)acrylate polymer of the aqueous adhesive composition in the first embodiment of the present disclosure may further include an internal crosslinking agent. When the (meth)acrylate polymer in the particulate polymer is internally crosslinked, the molecular weight of the (meth)acrylate polymer increases. As a result, the cohesive force of an adhesive to be obtained can be improved.

The aqueous adhesive composition in the first embodiment of the present disclosure can further contain an external crosslinking agent. When the particulate polymers are crosslinked to one another, the cohesive force of an adhesive to be obtained increases, and heat resistance can be improved.

A chlorine content of the chlorinated polyolefin present in the particulate polymer of the aqueous adhesive composition in the first embodiment of the present disclosure can be in the range of about 20 to about 26 mass %. An adhesive obtained by using a chlorinated polyolefin having such a chlorine content can have both improved adhesiveness and heat resistance.

An average particle size of the particulate polymer of the aqueous adhesive composition in the first embodiment of the present disclosure can be in the range of about 0.5 to about 20 μm. An adhesive obtained from an aqueous adhesive composition including a particulate polymer having such a particle size can have further improved adhesiveness.

The aqueous adhesive composition in the first embodiment of the present disclosure also has excellent flowability and thus can be used for spray coating.

A laminate in a second embodiment of the present disclosure can include a base material and an adhesive layer obtained from the aqueous adhesive composition in the first embodiment.

A structure in a third embodiment of the present disclosure may include a first adherend including a polyolefin resin and a second adherend that are bonded to each other via an adhesive layer obtained from the composition in the first embodiment.

A method for producing an aqueous adhesive composition containing a particulate polymer in a fourth embodiment of the present disclosure includes the steps of: compounding a chlorinated polyolefin in a (meth)acrylate monomer to prepare a solution; mixing and suspending the solution and water containing a surfactant to prepare a suspension including droplets incorporating the (meth)acrylate monomer and a dissolved chlorinated polyolefin; and compounding an oil soluble polymerization initiator in the suspension, and then polymerizing the (meth)acrylate monomer to prepare a particulate polymer containing a (meth)acrylate polymer and a chlorinated polyolefin. Since the particulate polymer prepared by such suspension polymerization has relatively uniform and large size as compared to a particulate polymer prepared by general emulsification polymerization, the surface area of the particulate polymer can be reduced. As a result, a proportion of a surfactant disposed near an interface between the particulate polymer and an aqueous dispersant and tending to inhibit adhesive strength can be reduced. Therefore, the adhesive strength of an adhesive to be obtained can be improved.

More detailed description will be provided below in order to exemplify typical embodiments of the present invention. The present invention, however, is not limited to these embodiments.

“(Meth)acrylate” in the present disclosure means acrylate or methacrylate. “(Meth)acryl” means acryl or methacryl.

A “(meth)acrylate polymer” in the present disclosure can also include a polymer generally called a “(meth)acrylate copolymer”.

“Curing” in the present disclosure can also include a concept generally called “crosslinking”.

The terminology of “alkyl” in the present disclosure means a straight chain or branched aliphatic hydrocarbon group. The terminology of “branched” in the present disclosure means that one or more alkyl groups, such as methyl, ethyl, or propyl, are attached to a straight chain shaped alkyl chain. The alkyl groups may be unsubstituted or may be substituted by one or more of halogen atoms, cycloalkyl groups, or cycloalkenyl groups.

The terminology of “cycloalkyl” in the present disclosure means a non-aromatic monocyclic or polycyclic ring-shaped system and includes, for example, about 3 to about 12 carbon atoms. Examples of the cycloalkyl ring include cyclopentyl, cyclohexyl, and cycloheptyl. This cycloalkyl group may also be substituted by one or more of a halogen atom, methylene, alkyl, cycloalkyl, heterocyclyl, aralkyl, heteroaralkyl, aryl, or heteroaryl. The terminology of “hetero” in the present disclosure means oxygen, nitrogen, or sulfur substituted with one or more carbon atoms.

The terminology of “cycloalkenyl” in the present disclosure means a non-aromatic monocyclic or polycyclic ring-shaped system having carbon-carbon double bonds and includes, for example, about 3 to about 10 carbon atoms. Examples of the cycloalkenyl group may be unsubstituted or may be substituted by one or more halogen atoms, methylene, alkyl, cycloalkyl, heterocyclyl, aralkyl, heteroaralkyl, aryl, or heteroaryl groups.

The terminology of “aryl” in the present disclosure means an aromatic carbocyclic radical. Examples of the aryl groups, which may optionally be the same or different, include phenyl or naphthyl substituted by one or more aryl substituents. Here, examples of the “aryl substituents” include hydrogen, alkyl, cycloalkyl, aryl optionally substituted, heteroaryl optionally substituted, aralkyl, aralkenyl, aralkynyl, heteroaralkyl, heteroaralkenyl, heteroaralkynyl, hydroxy, hydroxyalkyl, alkoxy, aryloxy, aralkoxy, carboxy, acyl, aroyl, halo, nitro, cyano, carboxy, alkoxycarbonyl, aryloxycarbonyl, aralkoxycarbonyl, acylamino, aroylamino, alkyl sulfonyl, aryl sulfonyl, and other known groups.

The chemical groups described above are known in the art. The description of these groups is not intended to change the generally accepted meanings thereof.

In the following, each component of the aqueous adhesive composition will further be described.

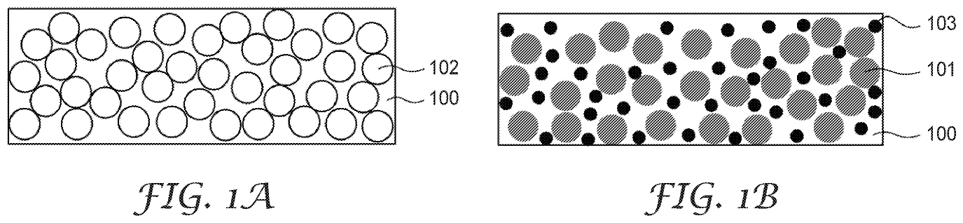

The aqueous adhesive composition in the present disclosure includes a particulate polymer containing a (meth)acrylate polymer and a chlorinated polyolefin. Since the chlorinated polyolefin is generally in a solid state at normal temperature, when the (meth)acrylate polymer and the chlorinated polyolefin are mixed in an aqueous dispersant, as illustrated in FIG. 1B, (meth)acrylate polymer particles 101 and solid-state chlorinated polyolefin particles 103 constitute the aqueous adhesive composition dispersed in an aqueous dispersant 100. On the other hand, since the chlorinated polyolefin in the present disclosure is incorporated together with the (meth)acrylate polymer in the particulate polymer in a dissolved state, as illustrated in FIG. 1A, it is believed that a particulate polymer 102 in which the (meth)acrylate polymer and the chlorinated polyolefin are integrated constitutes the aqueous adhesive composition dispersed in the aqueous dispersant 100.

When the aqueous adhesive composition including the configuration of FIG. 1B is applied to a base material, the (meth)acrylate polymer particles 101 can spread with respect to the base material. On the other hand, the solid-state chlorinated polyolefin particles 103 cannot spread with respect to the base material. Therefore, such particles 103 may become a factor of decreasing adhesiveness. When the solid-state chlorinated polyolefin particles 103 are melted under heating, wettability with respect to the base material can be increased. However, in this case, the base material may deform under heating. On the other hand, in the aqueous adhesive composition in the present disclosure including the configuration of FIG. 1A, both the (meth)acrylate polymer and the chlorinated polyolefin exist in dissolved state in the particulate polymer, and thus can spread with respect to the base material without the need for heating. As a result, the adhesive strength of an adhesive can be improved without deforming the base material.

There is no special limitation on compounding proportions of the (meth)acrylate polymer and the chlorinated polyolefin in the particulate polymer. For example, preferably, the compounding proportion of the chlorinated polyolefin is about 1.0 part by mass or more, about 2.0 parts by mass or more, or about 3.0 parts by mass or more and about 50 parts by mass or less, about 40 parts by mass or less, or about 30 parts by mass or less with respect to 100 parts by mass of the (meth)acrylate polymer 100 in consideration of adhesive strength, particularly, adhesive strength with respect to a polyolefin resin.

There is no special limitation on an average particle size of the particulate polymer. For example, the average particle size can be defined to be about 0.5 μm or more, about 0.7 μm or more, or about 0.9 μm or more and can be defined to be about 20 μm or less, about 15 μm or less, about 10 μm or less, about 5.0 μm or less, or about 3.0 μm or less, in consideration of the storage stability, adhesiveness, coatability, and the like of the aqueous adhesive composition. The average particle size of the particulate polymer can be derived by using, for example, a laser diffraction/scattering method.

There is no special limitation on a compounding amount of the particulate polymer in the aqueous adhesive composition. For example, the compounding amount of the particulate polymer in solid-content equivalent can be defined to be about 20 mass % or more, about 30 mass % or more, about 40 mass % or more, or about 50 mass % or more and can be defined to be about 80 mass % or less, about 70 mass % or less, or about 60 mass % or less, in consideration of the storage stability, adhesiveness, coatability, and the like of the aqueous adhesive composition. Since the aqueous adhesive composition in the present disclosure can be prepared in a state where the particulate polymer is dispersed in an aqueous dispersant, the particulate polymer can be compounded at a relatively high solid content as compared to a solvent type adhesive. As a result, since the content of the aqueous dispersant can be reduced, a production cost related to drying and the like can be reduced.

The (meth)acrylate polymer present in the particulate polymer can be obtained by polymerizing a monofunctional monomer and a monomer component optionally including a polyfunctional (meth)acrylate (may generally be referred to as a (meth)acrylate monomer”).

Examples of the monofunctional monomer can include an alkyl (meth)acrylate including an alkyl group having from 1 to 18 carbons (may be referred to as “C1-18 alkyl (meth)acrylate”) and an unsaturated monomer having a polar group (may be referred to as a “polar unsaturated monomer”). The monofunctional monomer can be used either alone or as a combination of two or more kinds.

For example, when the alkyl (meth)acrylate is considered as an ester of an acrylic acid and alkyl alcohol, the C1-18 alkyl (meth)acrylate means that the alkyl alcohol has from 1 to 18 carbons. That is, when the alkyl (meth)acrylate is expressed as CH₂═CH—COO—R¹, R¹ is an alkyl group having from 1 to 18 carbons.

The alkyl group in the alkyl (meth)acrylate preferably has 4 or more and 12 or less carbons. When such an alkyl (meth)acrylate is present as a monofunctional monomer, the adhesive strength or attachment force of an adhesive improves.

Examples of the alkyl (meth)acrylate include methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, n-pentyl (meth)acrylate, n-hexyl (meth)acrylate, 2-ethylhexyl (meth)acrylate, n-heptyl (meth)acrylate, n-octyl (meth)acrylate, isooctyl (meth)acrylate, n-nonyl (meth)acrylate, isononyl (meth)acrylate, n-decyl (meth)acrylate, n-undecyl (meth)acrylate, n-dodecyl (meth)acrylate, n-tridecyl (meth)acrylate, n-tetradecyl (meth)acrylate, n-pentadecyl (meth)acrylate, n-hexadecyl (meth)acrylate, n-heptadecyl (meth)acrylate, n-octadecyl (meth)acrylate, cyclohexyl (meth)acrylate, 3,3,5-trimethylcyclohexyl (meth)acrylate, and isobornyl (meth)acrylate, dicyclopentanyl (meth)acrylate, and the like. Among them, n-butyl (meth)acrylate, isobutyl (meth)acrylate, cyclohexyl methacrylate, 2-ethylhexyl (meth)acrylate are preferred in consideration of adhesiveness and the like.

There is no special limitation on a proportion of the C1-18 alkyl (meth)acrylate in polymerization of the (meth)acrylate polymer. For example, the proportion of the C1-18 alkyl (meth)acrylate can be about 90.0 parts by mass or more, about 91.0 parts by mass or more, or about 92.0 parts by mass and about 100 parts by mass or less, about 99.5 parts by mass or less, or about 99.0 parts by mass in the total amount 100 parts by mass of the monofunctional monomer.

In consideration of compatibility and adhesion with respect to the chlorinated polyolefin, as the C1-18 alkyl (meth)acrylate, (a) an alkyl (meth)acrylate having a glass transition temperature (referred to as Tg hereinafter) of a homopolymer being about 20° C. or more and (b) an alkyl (meth)acrylate being other than the monomer component (a) and including an alkyl group having from 4 to 18 carbons can be used together; preferably, (a) an alkyl (meth)acrylate having Tg in the range of about 20° C. or more and about 120° C. or less and (b) an alkyl (meth)acrylate other than the monomer component (a) and having from 4 to 12 carbons are used together; more preferably, (a) an alkyl (meth)acrylate having Tg in the range of about 20° C. or more and about 100° C. or less and (b) an alkyl (meth)acrylate other than the monomer component (a) and having from 4 to 8 carbons are used together. Here, the monomers in (a) and (b) may be referred to as the monomer component (a) and the monomer component (b).

Examples of a preferred monomer in the monomer component (a) can include methyl methacrylate (Tg: 105° C.), n-butyl methacrylate (Tg: 20° C.), isobutyl methacrylate (Tg: 48° C.), isostearyl methacrylate (Tg: 45° C.), cyclohexyl methacrylate (Tg: 83° C.), isobornyl acrylate (Tg: 94° C.), dicyclopentanyl acrylate (Tg: 120° C.), isobornyl methacrylate (Tg: 155° C.), and dicyclopentanyl methacrylate (Tg: 175° C.), and n-butyl methacrylate, isobutyl methacrylate, and cyclohexyl methacrylate are more preferred. These monomers can further improve adhesiveness and heat resistance.

When the monomer component (a) and the monomer component (b) are used together, although there is no special limitation, a proportion of the monomer component (a) can be about 10 parts by mass or more, about 20 parts by mass or more, or about 30 parts by mass or more and about 80 parts by mass or less, about 70 parts by mass or less, or about 60 parts by mass or less in the total amount 100 parts by mass of the monofunctional monomer. A proportion of the monomer component (b) can be about 10 parts by mass or more, about 20 parts by mass or more, or about 30 parts by mass or more and about 80 parts by mass or less, about 70 parts by mass or less, or about 60 parts by mass or less in the total amount 100 parts by mass of the monofunctional monomer.

The polar unsaturated monomer includes a vinyl group and a polar group.

Examples of the polar group include a hydroxyl group, a carboxyl group, an amide group, a carbamoyl group, an amino group, an epoxy group, a nitrile group, and a sulfonic acid group. Among them, a hydroxyl group, a carboxyl group, and an amide group are preferred, in consideration of adhesiveness, crosslinkability, and the like.

Examples of the vinyl group include a vinyl carbonyl group, a vinyl amide group, vinyl ester, and a styryl group. A vinyl carbonyl group is preferred. The vinyl carbonyl group refers to a group represented by CH₂═CH—C(═O). The vinyl carbonyl group and the polar group may be bonded directly to each other or bonded via a connection group such as an alkylene group.

Examples of the polar unsaturated monomer include

an unsaturated monomer containing a hydroxyl group, such as 2-hydroxyethyl (meth)acrylate, 3-hydroxypropyl (meth)acrylate, 4-hydroxybutyl (meth)acrylate, polyethylene glycol (meth)acrylate, and polypropylene glycol (meth)acrylate;

an unsaturated monomer containing a carboxyl group, such as (meth)acrylic acid, itaconic acid, maleic acid, and fumaric acid, and a salt thereof;

an unsaturated monomer containing an amide group, such as (meth)acryl amide, diacetone (meth)acryl amide, N-vinyl pyrrolidone, N-vinyl caprolactam, and N-vinyl formamide;

a monomer containing an amino group, such as N,N-dimethyl aminoethyl (meth)acrylate, N,N-diethyl aminoethyl (meth)acrylate, and N,N-dimethyl aminopropyl (meth)acrylate;

an unsaturated monomer containing an epoxy group, such as glycidyl (meth)acrylate;

an unsaturated monomer containing sulfonate, such as sodium styrene sulfonate.

In consideration of adhesiveness, heat resistance and the like, the unsaturated monomer containing a hydroxyl group, the unsaturated monomer containing a carboxyl group, and the unsaturated monomer containing an amide group are preferred, and 2-hydroxyethyl (meth)acrylate, (meth)acrylic acid, diacetone (meth)acryl amide are more preferred.

There is no special limitation on a proportion of the polar unsaturated monomer in polymerization of the (meth)acrylate polymer. For example, the proportion of the polar unsaturated monomer can be about 0.1 parts by mass or more, about 0.2 parts by mass or more, or about 0.3 parts by mass or more and about 5.0 parts by mass or less, about 3.0 parts by mass or less, or about 1.0 part by mass or less in the total amount 100 parts by mass of the monofunctional monomer.

Since the polyfunctional (meth)acrylate that is an optional component contributes to crosslinking inside the (meth)acrylate polymer in the particulate polymer, the polyfunctional (meth)acrylate can be referred to as an “internal crosslinking agent.” Since the internal crosslinking agent performs crosslinking inside the particulate polymer, the molecular weight and cohesive force of the particulate polymer can be improved. As a result, even when a primer or an organic solvent is attached to an adhesive layer, swelling of the adhesive layer or the like can be reduced. Unlike a solvent type adhesive, the aqueous adhesive composition in the present disclosure is a dispersion system in which the particulate polymer is dispersed in an aqueous dispersant. Therefore, even when such an internal crosslinking agent is used, the entire composition will not be gelled and can be applied to a base material or the like.

Examples of such an internal crosslinking agent include 1,6-hexanediol di(meth)acrylate, 1,9-nonanediol di(meth)acrylate, ethylene glycol di(meth)acrylate, polyethylene glycol di(meth)acrylate, propylene glycol di(meth)acrylate, polypropylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylol propane tri(meth)acrylate, and tetramethylol methane tri(meth)acrylate. These internal crosslinking agents can be used either alone or as a combination of two or more kinds. Among them, 1,6-hexanediol di(meth)acrylate is preferred, in consideration of cohesion and the like.

There is no special limitation on a proportion of the internal crosslinking agent in polymerization of the (meth)acrylate polymer. For example, the proportion of the internal crosslinking agent can be about 0.005 parts by mass or more, about 0.010 parts by mass or more, or about 0.015 parts by mass or more and about 0.50 parts by mass or less, about 0.10 parts by mass or less, or about 0.050 parts by mass or less per 100 parts by mass of the monofunctional monomer.

There is no special limitation on a polymerization initiator that can be used in polymerization of the (meth)acrylate polymer. For example, an oil soluble polymerization initiator can be used. Such a polymerization initiator is soluble in oil, and generally has very low solubility to water that is about 1 g per 100 g of water at 20° C. Examples of such a polymerization initiator include: an azo compound such as dimethyl 2,2′-azobis(2-methylpropionate); a, peroxide such as cumene hydroperoxide, and benzoyl peroxide; benzophenone; benzoin ethyl ether; and a 2,2-dimethoxy-2-phenyl acetophenone photopolymerization initiator. These polymerization initiators can be used either alone or as a combination of two or more kinds.

There is no special limitation on a proportion of the polymerization initiator in polymerization of the (meth)acrylate polymer. For example, the proportion of the polymerization initiator can be about 0.01 parts by mass or more, about 0.02 parts by mass or more, or about 0.03 parts by mass or more and about 2.0 parts by mass or less, about 1.5 parts by mass or less, or about 1.0 part by mass or less per 100 parts by mass of the (meth)acryl monomer (monofunctional monomer and polyfunctional (meth)acrylate when there is any).

The chlorinated polyolefin is a compound obtained by adding chlorine atoms to carbon atoms of a polyolefin. Examples of the chlorinated polyolefin include a chlorinated polyolefin obtained by chlorinating a copolymer formed with an α-olefin, such as propylene, ethylene, 1-butene, 1-pentene, 1-hexene, 1-heptene, 1-octene, and 4-methyl-1-pentene. The chlorinated polyolefin can also be a chlorinated polyolefin obtained by chlorinating a copolymer prepared by further graft polymerizing an acid component, such as α,β-unsaturated carboxylic acid such as maleic acid, maleic anhydride, fumaric acid, citraconic acid, citraconic anhydride, mesaconic acid, itaconic acid, itaconic anhydride, aconitic acid, aconitic anhydride, and himic anhydride to the above-described copolymer. These chlorinated polyolefins can be used either alone or in a combination of two or more kinds.

Heat of fusion of the chlorinated polyolefin is preferably about 0 J/g or more and about 5 J/g or less, about 3 J/g or less, or about 2 J/g or less in consideration of the compatibility, adhesive strength with respect to the (meth)acrylate polymer. Several types of chlorinated polyolefins can be mixed at a prescribed ratio. The heat of fusion in this case is measured by using the chlorinated polyolefins mixed at the prescribed ratio. The “heat of fusion of the chlorinated polyolefin” refers to the heat of fusion measured by differential scanning calorimetry (DSC) according to JIS K7121 (1987 edition). Specifically, after temperature is raised at a rate of 10° C./min from 23° C. to 180° C. in a nitrogen atmosphere in order to eliminate a heat history, the temperature is lowered at a rate of 10° C./min from 180° C. to −100° C., then the heat of fusion is measured while the temperature is raised at a rate of 10° C./min from −100° C. to 180° C.

A chlorine content in the chlorinated polyolefin is preferably in the range of about 16 to about 35 mass %, and more preferably in the range of about 19 to about 31 mass %, in consideration of adhesive strength, particularly, adhesive strength with respect to a polyolefin resin. When the chlorine content in the chlorinated polyolefin is in the range of about 20 to about 26 mass %, heat resistance can also be improved in addition to adhesive strength. Here, the chlorine content in the chlorinated polyolefin can be measured by an oxygen flask combustion method (according to JISK 7229 (1995 edition).

The chlorinated polyolefin can be produced by using, for example, the method described in JP 2004-217807 A. For example, a chlorinated polyolefin having the adjusted heat of fusion and chlorine content can be produced by appropriately adjusting a ratio between propylene and α-olefin and an amount of chlorine to be added in a copolymer of the above-described propylene and α-olefin. Available examples of such a chlorinated polyolefin include 803MWS, 822S, 930S of the Supercron (trademark) series produced by Nippon Paper Industries Co., Ltd., and Hardlen (trademark) DX-526P produced by Toyobo Co., Ltd.

The particulate polymer can also include, as optional components, a filler, a conductive agent, a heat conductive agent, an antioxidant, a UV absorbent, a photostabilizer, a thermal stabilizer, a dispersant, a plasticizer, a tackifier, a silane coupling agent, a catalyst, a pigment, and a dye, to the extent that the effect of the present invention is not affected.

The aqueous adhesive composition in the present disclosure can further contain an external crosslinking agent. The external crosslinking agent is a crosslinking agent for crosslinking the particulate polymers to one another. When the particulate polymers in the aqueous adhesive composition applied to a base material are crosslinked to one another, cohesive force and elasticity of an adhesive to be obtained increase. Therefore, the heat resistance of the adhesive can also be improved.

There is no special limitation on the external crosslinking agent as long as the external crosslinking agent can crosslink the particulate polymers to one another. For example, a general UV crosslinking agent, a thermal crosslinking agent, and the like can be used. A thermal crosslinking agent is preferred in consideration of operability and the like. Examples of such a thermal crosslinking agent can include a carbodiimide compound, a hydrazide compound, a (block) isocyanate compound, an aziridine compound, an oxazoline compound, an epoxy compound, a metal chelate compound, and an imine compound. These thermal crosslinking agents can be used either alone or as a combination of two or more kinds.

Among them, the carbodiimide compound is useful in terms of adhesion to a base material and low-temperature curability. Examples of the carbodiimide compound include V-02, V-02-L2, SV-02, V-04, V-10, SW-12G, E-02, E-03A, E-05A of Carbodilite (trademark) series produced by Nisshinbo Chemical Inc.

In addition, since the hydrazide compound has crosslinking reaction with a polymer containing a ketone group and is inactive in an aqueous suspension, and also since the hydrazide compound can form a crosslinked structure between the particulate polymers in a short period of time when water is removed, the hydrazide compound is useful. Examples of the hydrazide compound can include polyfunctional hydrazide such as oxalyl dihydrazide, malonyl dihydrazide, succinyl dihydrazide, glutaryl dihydrazide, adipic acid dihydrazide (ADH), maleyl dihydrazide, sebacoyl dihydrazide, dodecane dihydrazide, 7,11-octadecadiene-1,18-dicarbohydrazide, fumaroyl dihydrazide, isophthalic dihydrazide, terephthalic dihydrazide, aminopolyacrylamide, 1,3-bis(hydrazinocarbonoethyl)-5-isopropyl hydantoin (VDH), and mixtures thereof.

There is no special limitation on a proportion of the external crosslinking agent in the aqueous adhesive composition. For example, the proportion of the external crosslinking agent can be about 0.01 parts by mass or more, about 0.02 parts by mass or more, or about 0.03 parts by mass or more and about 5.0 parts by mass or less, about 4.0 parts by mass or less, or about 3.0 parts by mass or less per 100 parts by mass of the particulate polymer.

The particulate polymer in the aqueous adhesive composition in the present disclosure is dispersed in an aqueous dispersant. There is no special limitation on the aqueous dispersant, and as the aqueous dispersant, water such as distilled water, purified water, ion exchange water, and tap water can be used. In addition to such water, water soluble alcohol such as ethanol can also be used together to the extent that the effect of the present invention is not affected. The aqueous adhesive composition may include an organic solvent such as toluene in the range of about 1000 ppm or less. Preferably, however, the aqueous adhesive composition does not include such an organic solvent, in consideration of safety to a human body.

The aqueous adhesive composition in the present disclosure can include, as optional components, a filler, a conductive agent, a heat conductive agent, an antioxidant, a UV absorbent, a photostabilizer, a thermal stabilizer, a dispersant, a thickener, a tackifier, a plasticizer, a lubricant, a surfactant, a leveling agent, a silane coupling agent, a catalyst, a pigment, and a dye to the extent that the effect of the present invention is not affected. The aqueous adhesive composition in the present disclosure may also include other polymers in addition to the (meth)acrylate polymer and the chlorinated polyolefin. In this case, a proportion of the other polymers in the aqueous adhesive composition can be about 50 mass % or less, about 40 mass % or less, or about 30 mass % or less.

There is no special limitation on a method for producing the aqueous adhesive composition in the present disclosure. For example, hereinafter, a method for producing the aqueous adhesive composition by a suspension polymerization method will be described as an example.

A chlorinated polyolefin and the optional components described above are compounded in the above-described (meth)acrylate monomer under stirring and warming to prepare a solution in which the (meth)acrylate monomer and the chlorinated polyolefin are dissolved. Here, a chlorinated polyolefin preheated and dissolved may be compounded, but the chlorinated polyolefin may also be compounded in a solid form such as a pellet. There is no special limitation on a heating condition, and the heating condition can be defined to be, for example, about 40° C. or more, about 45° C. or more, or about 50° C. or more and about 80° C. or less, about 70° C. or less, or about 60° C. or less.

A surfactant is mixed with water to prepare a surfactant-containing water.

The surfactant-containing water and the above-described solution are mixed and suspended to prepare a suspension including droplets incorporating the (meth)acrylate monomer and the dissolved chlorinated polyolefin. The surfactant-containing water and the solution can be mixed by compounding the solution in the surfactant-containing water or by compounding the surfactant-containing water in the solution. However, it is preferred to compound the solution in the surfactant-containing water in consideration of the dispersion stability of the droplets. There is no special limitation on mixing means. For example, a mechanical stirring apparatus such as a homogenizer, an ultrasonic wave generating apparatus, or the like can be used. The above-described warming means may optionally be used together in mixing.

After an oil soluble polymerization initiator is compounded in the suspension, the above-described (meth)acrylate monomer is polymerized to prepare a particulate polymer containing the (meth)acrylate polymer and the chlorinated polyolefin. An external crosslinking agent and/or the above-described optional components can further be compounded to obtain an aqueous adhesive composition. There is no special limitation on polymerization temperature and polymerization time. For example, the polymerization temperature can be about 15° C. or more, about 20° C. or more, or about 25° C. or more and about 80° C. or less, about 75° C. or less, or about 70° C. or less. The polymerization time can be about 1 hour or more, about 3 hours or more, or about 5 hours or more and about 24 hours or less, about 22 hours or less, or about 20 hours or less.

An aging step may optionally be applied after the end of the polymerization. There is no special limitation on conditions of the aging step. For example, aging temperature can be about 50° C. or more, about 55° C. or more, or about 60° C. or more and about 80° C. or less, about 75° C. or less, or about 70° C. or less. Aging time can be about 1 hour or more, about 1.5 hours or more, or about 2 hours or more and about 6 hours or less, about 5 hours or less, or about 4 hours or less.

According to the method for producing the aqueous adhesive composition in the present disclosure, the chlorinated polyolefin can exist in the particulate polymer in a dissolved state. As a result, the chlorinated polyolefin can spread together with the (meth)acrylate polymer with respect to a base material. Therefore, the adhesive strength of an adhesive can be improved.

It is preferred to prepare the aqueous adhesive composition in the present disclosure by using the above-described suspension polymerization method. An oil soluble polymerization initiator is used in the suspension polymerization method in the present disclosure. The added oil soluble polymerization initiator penetrates into the droplets that are equivalent to oil and that include the (meth)acrylate monomer and the chlorinated polyolefin. Polymerization is completed within the droplets that are closed areas. Therefore, a particulate polymer having a relatively uniform particle size is easy to obtain.

Since the particulate polymer obtained by the suspension polymerization method in the present disclosure generally has a relatively larger size than a particulate polymer prepared by an emulsification polymerization method, the surface area of the particulate polymer can be reduced. As a result, the proportion of the surfactant disposed near an interface between the particulate polymer and the aqueous dispersant and making no contribution to adhesiveness can be reduced. Therefore, the adhesive strength of an adhesive can be improved.

For example, the aqueous adhesive composition in the present disclosure can be applied to a base material, followed by drying and optional crosslinking treatment, such as heating, to form an adhesive layer to obtain a laminate. Such a laminate can further include a member to be coated. The aqueous adhesive composition in the present disclosure can be applied to the member to be coated in the same way as to the base material. Here, the crosslinking treatment can be carried out by a separate crosslinking treatment step on a production line or by taking advantage of the heat in a drying step or the like.

There is no special limitation on means for applying the aqueous adhesive composition to the base material. Examples of the means can include a known coating method such as spray coating, gravure coating, roll coating, die coating, bar coating, and knife coating. Even though the aqueous adhesive composition in the present disclosure can have a high solid content, the aqueous adhesive composition can have a relatively low viscosity and maintain a flowable state, and thus the aqueous adhesive composition can be used for spray coating applicable to a base material having a relatively complicated shape.

The aqueous adhesive composition in the present disclosure is in the state illustrated in FIG. 1A right after the aqueous adhesive composition is applied to the base material. However, when drying is performed from that state, the proportion of the aqueous dispersant 100 is reduced. An adhesive layer including the particulate polymer 102 being in a dense state is formed. Since the cohesive force and elasticity of the adhesive layer increase as the particulate polymer 102 becomes dense, it is believed that the adhesive layer to be obtained can provide sufficient adhesive strength.

When the aqueous adhesive composition further includes an external crosslinking agent, the particulate polymers in the dense state are crosslinked to one another and cohesive force and elasticity can further increase. Therefore, heat resistance can also be improved in addition to adhesive strength.

The adhesive strength of the adhesive layer can be evaluated by using, for example, a peeling strength test described below.

Peeling strength can be defined to be, for example, about 8.0 N/25 mm or more, about 8.5 N/25 mm or more, or about 9.0 N/25 mm or more. There is no special limitation on an upper limit of the peeling strength, and the upper limit can be defined to be, for example, about 35.0 N/25 mm or less, about 30.0 N/25 mm or less, or about 25.0 N/25 mm or less.

The heat resistance of the adhesive layer can be evaluated by using, for example, a 90-degree creep test described below. In such a test, the heat resistance can be evaluated based on the width, temperature, load, and peeling distance of a test piece.

For examples, when a test piece having a width of 25 mm is placed in an 80° C. oven and a 100-g weight is suspended, a peeling distance in such a test can be defined to be, for example, about 15 mm or less, about 12 mm or less, or about 10 mm or less. There is no special limitation on a lower limit of the peeling distance, and can be defined to be, for example, about 0.0 mm or more or more than about 0.0 mm.

The thickness of the adhesive layer is selected appropriately, in consideration of required adhesive strength. For example, the thickness of the adhesive layer can be, but is not limited to, about 3 μm or more, about 5 μm or more, about 10 μm or more, or about 20 μm or more, and about 200 μm or less, about 150 μm or less, or about 100 μm or less.

There is no special limitation on the base material (may be referred to as a first adherend) to which the aqueous adhesive composition in the present disclosure is applied. For example, the base material may have a flat shape like a film or a plate, a curved shape, or any three-dimensional shape. The base material may be nonwoven fabric, woven fabric, knitted fabric, a net-shaped article, foam, or the like. Such a base material can be used either alone or in a combination of two or more kinds. A surface treatment such as corona treatment and primer treatment may be applied to a surface of the base material. However, since the adhesive layer obtained from the aqueous adhesive composition in the present disclosure has excellent adhesiveness, the adhesive layer can be used as a base material to which such surface treatment is not applied.

There is no special limitation on a material of the base material. Examples of the base material can include: a polyolefin resin such as polyethylene, and polypropylene; a polyester resin such as polyethylene terephthalate (PET); a vinyl chloride resin; a cellulose acetate resin; a polyacetate resin; an ethylene vinyl acetate copolymer (EVA); a polyamide resin; a polyimide resin; a polymethyl pentene resin; a rubber material; natural or artificial leather; a metal such as aluminum or a metal alloy; glass; ceramics; and an inorganic material such as concrete, paper, cotton cloth, and a wood material. These materials can be used either alone or as a blend of two or more kinds. Alternatively, a combination of two or more kinds of these materials such as, for example, a configuration where a polyolefin resin member and a polyester resin member are integrated may be used. Among them, since the aqueous adhesive composition in the present disclosure includes the dissolved chlorinated polyolefin that can improve adhesiveness to a polyolefin resin, a base material including a polyolefin resin, particularly, a polypropylene resin is preferred as the base material.

As a member to be bonded (which may be referred to as a second adherend), the same material as the above-described base material can be used. The base material and the member to be bonded may be made of the same material or different materials. For example, both the base material and the member to be bonded may be made of a polyolefin resin, or the base material may be made of a polyolefin resin, while the member to be bonded may be made of artificial leather.

Since the aqueous adhesive composition in the present disclosure can be used for spray coating, the aqueous adhesive composition can be applied to base materials having various shapes. Consequently, a laminate obtained by using the aqueous adhesive composition in the present disclosure is not limited to a form of an adhesive tape, a masking tape, or the like but can also be used as various types of structures, including the first and second adherends. Among them, it is preferred to use the laminate as an interior member for a transportation tool such as an automobile, a train, an airplane, and a boat, or for construction, for which suppression of scattering of a volatile chemical substance such as toluene and aldehyde is desired.

Since the aqueous adhesive composition in the present disclosure including the external crosslinking agent can also improve the heat resistance of an adhesive layer to be obtained, an interior member for a vehicle, such as an installment panel, a pillar trim, a door rim, and a roof trim, that can be exposed to high-temperature environment is particularly preferred among the above-described interior members. A method for producing an interior member for a vehicle will be described below as an example.

For example, a base material made of polypropylene and having a shape like a door trim is prepared. The aqueous adhesive composition in the present disclosure is spray coated to the base material (first adherend), followed by heating and drying in an oven or the like to form an adhesive layer on the base material. Then, a member to be bonded (second adherend) made of artificial leather or the like in which polyurethane foam, spunlace, or the like may be laminated can be laminated on the adhesive layer on the base material to obtain an interior member for a vehicle. Here, the member to be bonded made of artificial leather or the like may be preheated before being laminated on the base material. Heat treatment may also be performed on the laminate including the base material and the member to be bonded. Heating and drying conditions, preheating conditions, and conditions for the heat treatment performed during laminating can be set appropriately, in consideration of adhesiveness, the base material to be used, and the material of the member to be bonded.

### EXAMPLES

In the following examples, the specific embodiments of the present disclosure will be exemplified. The present invention, however, is not limited to these examples. All parts and percentages are by mass unless specified otherwise.

Products and the like used in the examples are listed in Table 1 below.

TABLE 1

| | Compound name, | | |
|---|---|---|---|
| | product name or | | |
| Component | abbreviation | Explanation | Manufacturers |
| Monomer | 2EHA | 2-ethylhexyl acrylate (Tg of homopolymer −70° C.) | Nippon Shokubai Co., Ltd. (Chuo-ku, Osaka-shi, |
| | | | Japan) |
| | nBA | n-butyl acrylate (Tg of homopolymer −55° C.) | Mitsubishi Chemical Corporation (Chiyoda-ku, Tokyo, |
| | | | Japan) |
| | nBMA | n-butyl methacrylate (Tg of homopolymer 20° C.) | Mitsubishi Chemical Corporation (Chiyoda-ku, Tokyo, |
| | | | Japan) |
| | IBMA | isobutyl methacrylate (Tg of homopolymer 48° C.) | Mitsubishi Chemical Corporation (Chiyoda-ku, Tokyo, |
| | | | Japan) |
| | CHMA | cyclohexyl methacrylate (Tg of homopolymer 83° | Mitsubishi Chemical Corporation (Chiyoda-ku, Tokyo, |
| | | C.) | Japan) |
| | MMA | methyl methacrylate (Tg of homopolymer 105° C.) | Mitsubishi Chemical Corporation (Chiyoda-ku, Tokyo, |
| | | | Japan) |
| | DAAM | diacetone acryl amide | Nippon Chemical Industrial Co., Ltd. (Koto-ku, Tokyo, |
| | | | Japan) |
| | HEMA | 2-hydroxyethyl methacrylate | Nippon Shokubai Co., Ltd. (Chuo-ku, Osaka-shi, |
| | | | Japan) |
| | AA | Acrylic acid | Toagosei Co., Ltd. (Minato-ku, Tokyo, Japan) |
| Internal | HDDA | 1,6-hexanediol diacrylate | Kyoeisha Chemical Co., Ltd. (Chuo-ku, Osaka-shi, |
| crosslinking | | | Japan) |
| agent | HDDMA | 1,6-hexanediol dimethacrylate | Fujifilm Wako Pure Chemical Co., Ltd. (Chuo-ku, |
| | | | Osaka-shi, Japan) |
| Tackifier | Arkon (trademark) | Acyclic saturated hydrocarbon resin having 9 | Arakawa Chemical Industries, Ltd. (Chuo-ku, Osaka- |
| | P140 | carbons | shi, Japan) |
| | | Softening point: 140° C. | |
| | Arkon (trademark) | Partially hydrogenated C9 (9 carbons) resin | Arakawa Chemical Industries, Ltd. (Chuo-ku, Osaka- |
| | M135 | | shi, Japan) |
| Chlorinated | Supercron (trademark) | Pellet of acid modified chlorinated polyolefin | Nippon Paper Industries Co., Ltd. (Chiyoda-ku, Tokyo, |
| polyolefin | 930S | Melting point: 55° C., chlorine content: 21 mass % | Japan) |
| | Supercron (trademark) | Pellet of acid modified chlorinated polyolefin | Nippon Paper Industries Co., Ltd. (Chiyoda-ku, Tokyo, |
| | 822S | Melting point: 85° C., chlorine content: 25 mass % | Japan) |
| | Supercron (trademark) | Pellet of chlorinated polyolefin | Nippon Paper Industries Co., Ltd. (Chiyoda-ku, Tokyo, |
| | 803MWS | Melting point: 75° C., chlorine content: 30 mass % | Japan) |
| | Hardlen (trademark) | Pellet of chlorinated polyolefin | Toyobo Co., Ltd. (Kita-ku, Osaka-shi, Japan) |
| | DX-526P | Melting point: 81° C., chlorine content: 27 mass % | |
| | Supercron (trademark) | Aqueous chlorinated polyolefin (emulsion type) | Nippon Paper Industries Co., Ltd. (Chiyoda-ku, Tokyo, |
| | E-480T | (solid content 30%) | Japan) |
| | | Chlorine content: 20 mass % | |
| Oil soluble | V601 | Dimethyl 2,2′-azobis(2-methylpropionate) | Fujifilm Wako Pure Chemical Co., Ltd. (Chuo-ku, |
| polymerization | | | Osaka-shi, Japan) |
| initiator | | | |
| Surfactant | Aqualon (trademark) | Anionic surfactant (solid content 25%) | DKS Co., Ltd. (Minami-ku, Kyoto-shi, Japan) |
| | BC1025 | | |
| External | Carbodilite (trademark) | Aqueous crosslinking agent prepared by adding | Nisshinbo Chemical Inc. (Chuo-ku, Tokyo, Japan) |
| crosslinking | V-10 | hydrophilic segments to a polycarbodiimide resin | |
| agent | | (effective component 40%) | |
| | ADH | Adipic acid dihydrazide (5% aqueous solution) | Fujifilm Wako Pure Chemical Co., Ltd. (Chuo-ku, |
| | | | Osaka-shi, Japan) |
| Thickener | SN Thickener 612 | Urethane-modified polyether | San Nopco Ltd. (Chuo-ku, Tokyo, Japan) |
| | ADEKANOL UH-752 | Nonionic polymer surfactant | Adeka Co., Ltd. (Arakawa-ku, Tokyo) |
| Other | Shoprene (trademark) | Emulsified chloroprene rubber | Showa Denko K. K. (Minato-ku, Tokyo, Japan) |
| polymers | SD753 | | |

The materials shown in Table 1 were used to prepare suspensions 1 to 12 including particulate polymers in the compounding proportions shown in Table 2 according to a method described below. Here, all of the numeric values in Table 2 represent parts by mass. The average particle size of the particulate polymer is a value derived by a laser diffraction/scattering method using a particle size distribution measurement device (LS 13 320) produced by Beckman Coulter., Inc.

TABLE 2

| | | Suspension | Suspension | Suspension | Suspension | Suspension | Suspension |
|---|---|---|---|---|---|---|---|
| Components | | 1 | 2 | 3 | 4 | 5 | 6 |
| Monomer | 2EHA | 50.0 | 60.0 | 50.0 | 50.0 | 50.0 | 50.0 |
| | nBA | — | — | 10.0 | 10.0 | 100 | 10.0 |
| | nBMA | 48.5 | 33.5 | 33.5 | 33.5 | 33.5 | 33.5 |
| | MMA | — | 5.0 | 5.0 | 5.0 | 5.0 | 5.0 |
| | IBMA | — | — | — | — | — | — |
| | CHMA | — | — | — | — | — | — |
| | DAAM | 1.0 | — | — | — | — | — |
| | HEMA | — | 1.0 | 1.0 | 1.0 | 1.0 | 1.0 |
| | AA | 0.5 | 0.5 | 0.5 | 0.5 | 0.5 | 0.5 |
| Internal | HDDA | — | — | 0.020 | 0.020 | 0.020 | 0.020 |
| crosslinking | HDDMA | 0.020 | 0.020 | — | — | — | — |
| agent | | | | | | | |
| Tackifier | Arkon | 25.0 | 10.0 | — | — | — | — |
| | (trademark) P140 | | | | | | |
| Chlorinated | Supercron | 10.0 | 10.0 | 10.0 | — | — | — |
| polyolefin | (trademark) 930S | | | | | | |
| | Supercron | — | — | — | 10.0 | — | — |
| | (trademark) 822S | | | | | | |
| | Supercron | — | — | — | — | 10.0 | — |
| | (trademark) 803MWS | | | | | | |
| | Hardlen | — | — | — | — | — | 10.0 |
| | (trademark) DX-526P | | | | | | |
| Oil soluble | V601 | 0.2 | 0.2 | 0.2 | 0.2 | 0.2 | 0.2 |
| polymerization | | | | | | | |
| initiator | | | | | | | |
| Surfactant | Solid content | 1.0 | 1.0 | 1.0 | 1.0 | 1.0 | 1.0 |
| | of Aqualon | | | | | | |
| | (trademark) BC1025 | | | | | | |
| Average particle size of particulate | | 1.7 | 2.0 | 1.7 | 1.5 | 1.5 | 1.5 |
| polymer (μm) | | | | | | | |
| | | Suspension | Suspension | Suspension | Suspension | Suspension | Suspension |
| Components | | 7 | 8 | 9 | 10 | 11 | 12 |
| Monomer | 2EHA | 50.0 | 70.0 | 30.0 | 27.0 | 27.0 | 17.5 |
| | nBA | 10.0 | — | 40.0 | 17.0 | 34.0 | 51.0 |
| | nBMA | 33.5 | 28.5 | 23.5 | 54.0 | — | — |
| | MMA | 5.0 | — | 5.0 | — | 10.0 | — |
| | IBMA | — | — | — | — | 27.0 | — |
| | CHMA | — | — | — | — | — | 30.0 |
| | DAAM | — | 1.0 | — | 1.0 | 1.0 | 1.0 |
| | HEMA | 1.0 | — | 0.5 | — | — | — |
| | AA | 0.5 | 0.5 | 1.0 | 1.0 | 1.0 | 0.5 |
| Internal | HDDA | 0.020 | — | 0.015 | 0.020 | 0.020 | 0.020 |
| crosslinking | HDDMA | — | 0.020 | — | — | — | — |
| agent | | | | | | | |
| Tackifier | Arkon | — | — | — | — | — | — |
| | (trademark) P140 | | | | | | |
| Chlorinated | Supercron | — | 5.0 | 10.0 | — | — | — |
| polyolefin | (trademark) 930S | | | | | | |
| | Supercron | — | — | — | 10.0 | 10.0 | 10.0 |
| | (trademark) 822S | | | | | | |
| | Supercron | — | — | — | — | — | — |
| | (trademark) 803MWS | | | | | | |
| | Hardlen | — | — | — | — | — | — |
| | (trademark) DX-526P | | | | | | |
| Oil soluble | V601 | 0.2 | 0.2 | 0.2 | 0.2 | 0.2 | 0.2 |
| polymerization | | | | | | | |
| initiator | | | | | | | |
| Surfactant | Solid content | 1.0 | 1.0 | 1.0 | 1.0 | 1.0 | 1.0 |
| | of Aqualon | | | | | | |
| | (trademark) BC1025 | | | | | | |

| | | | | | | |
|---|---|---|---|---|---|---|
| Average particle size of particulate | 3.3 | 1.7 | 3.0 | 0.94 | 0.91 | 1.2 |
| polymer (μm) | | | | | | |

### Suspension 1

50.0 g of 2EHA, 48.5 g of nBA, 1.0 g of DAAM, and 0.5 g of AA as monomers and 0.020 g of HDDMA as an internal crosslinking agent were added into a container and were stirred and mixed under warming at about 50° C. 25.0 g of Arkon (trademark) P140 as a tackifier and 10.0 g of Supercron (trademark) 930S as a chlorinated polyolefin were further added into the container and were stirred and mixed under warming at about 50° C. to prepare a solution. 4.0 g (of which the solid content is 1.0 g that is 25%) of Aqualon (trademark) BC1025 as a surfactant was added into another container, followed by mixing ion exchange water to prepare 22.5 g of surfactant-containing water. The above-described solution was added into the surfactant-containing water, and was treated with a homogenizer (produced by Primix Corporation) for 15 min to prepare a mixture. Subsequently, 0.20 g of V601 that is an oil soluble polymerization initiator was added into this mixture, followed by nitrogen purging and heating at 65° C. for 20 hours for polymerization to obtain suspension 1. The obtained suspension included almost no aggregate, and had good storage stability.

### Suspensions 2 to 12

Suspensions 2 to 12 were prepared in the same way as suspension 1 except that the compounding proportions were changed as shown in Table 2.

Aqueous adhesive compositions of Examples 1 to 12 and Comparative Examples 1 to 2 were prepared by using obtained suspensions 1 to 12 in the compounding proportions shown in Table 3 according to a method described below. Here, the numeric values in Table 3 all represent parts by mass.

### EXAMPLE 1

20.0 g of suspension 1 was added into a container, followed by adding 0.10 g of SN Thickener 612 as a thickener. A degassable centrifugal stirrer was used to perform stirring and mixing under the conditions of 0.2 Torr and 2000 rpm for 90 sec. Then, 0.60 g of Carbodilite (trademark) V-10 was added as an external crosslinking agent into the container, followed by using a degassable centrifugal stirrer to further stir and mix under the same conditions to obtain an aqueous adhesive composition.

### EXAMPLES 2 TO 12 AND COMPARATIVE EXAMPLES 1 TO 2

The aqueous adhesive compositions of Examples 2 to 12 and Comparative Examples 1 to 2 were prepared in the same way as described in Example 1 except that the compounding proportions were changed as shown in Table 3. Here, in Example 7, Shoprene (trademark) SD753 was added as another polymer together with SN Thickener 612. In Example 8, no SN Thickener 612 was used and ADH was used together as an external crosslinking agent. In Examples 9 to 12, no SN Thickener 612 was used. In Comparative Example 2, Supercron (trademark) E-480T (chlorination rate 20%), which is an emulsified chlorinated polyolefin, was added.

### Physical Property Evaluation Tests

The physical properties of an adhesive obtained from each aqueous adhesive composition were evaluated by using the following methods.

### Peeling Strength Test

After the aqueous adhesive composition was spray coated on a polypropylene sheet (produced by Test Piece Corporation) having dimensions of length 100 mm×width 25 mm×thickness 2.0 mm, the sheet was disposed in an oven, and drying was performed at about 80° C. for about 2 min to form an adhesive layer. A canvas sheet that is a member to be bonded and that has dimensions of length 225 mm×width 30 mm×thickness 0.5 mm was heat treated in the same oven. Then, the canvas sheet was bonded to the adhesive layer on the polypropylene sheet. The canvas sheet side was rolled by a 2 kg rubber roller back and forth three times to perform lamination and prepare a test piece. The test piece was left to stand at still at room temperature (about 25° C.) for about 24 hours. The extra canvas sheet was cut off. Then, this test piece was set in a tensile testing machine (AG-IS, produced by Shimadzu Corporation), and the 180-degree peeling strength of such a test piece was measured at a peeling velocity of 200 mm/min. The measurement was performed three times for each test piece. The average value of the peeling strength obtained in all the measurement is shown in Table 3.

### Heat Resistance Test: 90-Degree Creep

After the aqueous adhesive composition was spray coated on a polypropylene sheet (produced by Test Piece Corporation) having dimensions of length 100 mm×width 25 mm×thickness 2.0 mm, the sheet was disposed in an oven, and drying was performed at about 80° C. for about 3 min to form an adhesive layer. A canvas sheet that is a member to be bonded and that has dimensions of length 225 mm×width 30 mm×thickness 0.5 mm was heat treated in the same oven. Then, the canvas sheet was bonded to the adhesive layer on the polypropylene sheet. The canvas sheet side was rolled by a 2 kg rubber roller back and forth three times to perform lamination and prepare a test piece. This test piece was left to stand at still at room temperature (about 25° C.) for about 24 hours. Subsequently, the extra canvas sheet was cut off except for a portion (about length 50 mm×width 25 mm) for hanging a weight. Then, a 100 g weight was attached to the nearly central part in the lateral direction of the extra canvas sheet where no adhesive was applied. The test piece was disposed in an oven at a temperature of about 80° C. such that the polypropylene sheet was in the nearly horizontal direction with respect to the ground surface, the weight became nearly 90° with respect to the polypropylene sheet, and the 100 g weight had no contact with the oven or the like. After about 24 hours, the test piece was removed. The distance in which the adhesive layer peeled off (peeling distance) was measured between a position of an end portion of the adhesive prior to the test on the side where the weight was attached and a position of the end portion of the adhesive after the test. The measurement was performed twice for each test piece. The average value of the peeling distances obtained in all the measurement is shown in Table 3. Here, the smaller the average value of the peeling distances, the better heat resistance.

TABLE 3

| Components | | [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|---|
| Suspension | 1 | 20.0 | — | — | — | — | — | — | — | 15.0 | — | — | — | — | — |
| | 2 | — | 20.0 | — | — | — | — | — | — | — | — | — | — | — | — |
| | 3 | — | — | 20.0 | — | — | — | — | — | — | — | — | — | — | — |
| | 4 | — | — | — | 20.0 | — | — | — | — | — | — | — | — | — | — |
| | 5 | — | — | — | — | 20.0 | — | — | — | — | — | — | — | — | — |
| | 6 | — | — | — | — | — | 20.0 | — | — | — | — | — | — | — | — |
| | 7 | — | — | — | — | — | — | 20.0 | 18.2 | — | — | — | — | — | — |
| | 8 | — | — | — | — | — | — | — | — | — | 20.0 | — | — | — | — |
| | 9 | — | — | — | — | — | — | — | — | — | — | 20.0 | — | — | — |
| | 10 | — | — | — | — | — | — | — | — | — | — | — | 20.0 | — | — |
| | 11 | — | — | — | — | — | — | — | — | — | — | — | — | 20.0 | — |
| | 12 | — | — | — | — | — | — | — | — | — | — | — | — | — | 20.0 |
| Other | Shoprene | — | — | — | — | — | — | — | — | 5.0 | — | — | — | — | — |
| polymers | (trademark) | | | | | | | | | | | | | | |
| | SD753 | | | | | | | | | | | | | | |
| Thickener | SN Thickener | 0.10 | 0.10 | 0.10 | 0.10 | 0.10 | 0.10 | 0.10 | — | 0.10 | — | — | — | — | — |
| | 612 | | | | | | | | | | | | | | |
| External | ADH | — | — | — | — | — | — | — | — | — | 0.36 | — | — | — | — |
| crosslinking | Carbodilite | 0.60 | 0.60 | 0.60 | 0.60 | 0.60 | 0.60 | 0.60 | 0.60 | 0.30 | — | 0.60 | 0.60 | 0.60 | 0.60 |
| agent | (trademark) | | | | | | | | | | | | | | |
| | V-10 | | | | | | | | | | | | | | |
| Emulsion | Solid content | — | — | — | — | — | — | — | 3.6 | — | — | — | — | — | — |
| type | of Supercron | | | | | | | | | | | | | | |
| chlorinated | (trademark) | | | | | | | | | | | | | | |
| polyolefin | E-480T | | | | | | | | | | | | | | |
| Evaluation | Room Temp. | — | — | — | — | — | — | — | 3.6 | — | — | — | — | — | — |
| | Peeling strength | | | | | | | | | | | | | | |
| | (N/25 mm) | | | | | | | | | | | | | | |
| | Heat Resistance | 0.0 | 3.5 | 1.5 | 1.8 | More | More | More | More | 1.0 | 7.0 | 0.0 | 0.0 | 0.0 | 0.0 |
| | 90 degree Creep | | | | | than 30 | than 30 | than 30 | than 30 | | | | | | |
| | Peeling distance | | | | | | | | | | | | | | |
| | (mm) | | | | | | | | | | | | | | |

[symbol]

indicates data missing or illegible when filed

### Suspensions 13 to 17

Suspensions 3 to 17 were prepared in the same way as suspension 1 except that the compounding proportions were changed as shown in Table 4.

TABLE 4

| Components | | Suspension 13 | Suspension 14 | Suspension 15 | Suspension 16 | Suspension 17 |
|---|---|---|---|---|---|---|
| Monomer | 2EHA | 35.5 | 35.5 | 35.5 | 35.5 | 53.5 |
| | nBMA | 63.0 | 63.0 | 63 0 | 63.0 | 45 |
| | DAAM | 0 50 | 0.30 | 0.30 | 0.30 | 0.30 |
| | HEMA | 0.50 | 0.20 | 0.20 | 0.20 | 0.20 |
| | AA | 0 50 | 1.0 | 1.0 | 1.0 | 1.0 |
| Internal crosslinking agent | HDDA | 0.010 | 0.010 | 0.020 | 0.020 | 0.020 |
| Tackifier | Arkon (trademark) P140 | 10 | | | 5 | |
| | Arkon (trademark) M135 | | 5 | 5 | | 5 |
| Chlorinated polyolefin | Supercron (trademark) 822S | 10 | 5 | 5 | 5 | 5 |
| Oil soluble | V601 | 0.10 | 0.10 | 0.10 | 0.10 | 0.10 |
| polymerization initiator | | | | | | |
| Surfactant | Solid content of Aqualon | 1.0 | 1.0 | 1.0 | 1.0 | 1.0 |
| | (trademark) BC1025 | | | | | |

| | | | | | |
|---|---|---|---|---|---|
| Average particle size of particulate polymer (μm) | 1.5 | 1.4 | 1.2 | 1.6 | 1.5 |

### EXAMPLES 13 TO 18

The aqueous adhesive compositions of Examples 13 to 18 were prepared in the same way as described in Example 1 except that the compounding proportions were changed as shown in Table 5.

### Physical Property Evaluation Tests for Examples 13 to 18

The physical properties of an adhesive obtained from each aqueous adhesive composition were evaluated by using the following methods.

### Preparation of Test Piece for Example 13, 14 and 17

After the aqueous adhesive composition was spray coated on a polypropylene based thermoplastic elastomer (TPO) plate having dimensions of length 100 mm×width 25 mm×thickness 2.0 mm), the sheet was disposed in an oven, and drying was performed (mildly) at 55° C. for about 2 min. Wet weight was 100g/sqm. A decorative sheet (skin material) that is a member to be bonded and that has dimensions of length 200 mm×width 30 mm×thickness 0.5 mm, and contain vinyl layer (0.1 mm)/polyurethane foam layer (3 mm)/spun lace layer (0.05 mm) was applied on the TPO plate (to be facing the spun-lace layer and the TPO plate), and pressed with 1 kg/sqm for 10 sec to perform lamination and prepare a test piece. This test piece was left to stand at still at room temperature (about 25° C.) for about 24 hours. Subsequently, the extra decorative sheet was cut off except for a portion (about length 50 mm×width 25 mm) for hanging a weight.

### Preparation of Test Piece for Example 15, 16 and 18

After the aqueous adhesive composition was spray coated on a polypropylene based thermoplastic elastomer (TPO) plate having dimensions of length 100 mm×width 25 mm×thickness 2.0 mm), the sheet was disposed in an oven, and drying was performed at 70° C. for about 2 min. Wet weight was 100g/sqm. Also, After the aqueous adhesive composition was spray coated on a spun-lace layer of a decorative sheet (skin material) that is a member to be bonded and that has dimensions of length 200 mm×width 30 mm×thickness 0.5 mm, and contain vinyl layer (0.1 mm)/polyurethane foam layer (3 mm)/spun-lace layer (0.05 mm), the sheet was disposed in an oven, and drying was performed at 70° C. for about 2 min. The decorative sheet was applied on the TPO plate (to be facing the spun-lace layer and the TPO plate), and pressed with 1 kg/sqm for 10 sec to perform lamination and prepare a test piece. This test piece was left to stand at still at room temperature (about 25° C.) for about 24 hours. Subsequently, the extra decorative sheet was cut off except for a portion (about length 50 mm×width 25 mm) for hanging a weight.

### Room Temperature Peeling Strength Test:

The test piece was set in a tensile testing machine (AG-IS, produced by Shimadzu Corporation), and the 180-degree peeling strength of such a test piece was measured at a peeling velocity of 200 mm/min. The measurement was performed three times for each test piece. The average value of the peeling strength obtained in all the measurement is shown in Table 5.

### Heat Resistance Peeling Strength Test

The test piece was set in a tensile testing machine (AG-IS, produced by Shimadzu Corporation), the test piece was leaved for 30 min in the oven chamber at 80° C. And the 180-degree peeling strength of such a test piece was measured at a peeling velocity of 200 mm/min in the oven chamber at 80° C. The measurement was performed three times for each test piece. The average value of the peeling strength obtained in all the measurement is shown in Table 5.

### Heat Resistance 90-Degree Creep Test

A 100 g weight was attached to the nearly central part in the lateral direction of the extra decorative sheet where no adhesive was applied. The test piece was disposed in an oven at a temperature of about 80° C. such that the TPO plate was in the nearly horizontal direction with respect to the ground surface, the weight became nearly 90° with respect to the TPO plate, and the 100 g weight had no contact with the oven or the like. After about 24 hours, the test piece was removed. The distance in which the adhesive layer peeled off (peeling distance) was measured between a position of an end portion of the adhesive prior to the test on the side where the weight was attached and a position of the end portion of the adhesive after the test. The measurement was performed twice for each test piece. The average value of the peeling distances obtained in all the measurement is shown in Table 5.

TABLE 5

| Components | | Example 13 | Example 14 | Example 15 | Example 16 | Example 17 | Example 18 |
|---|---|---|---|---|---|---|---|
| Suspension | 13 | 100 | — | — | — | — | — |
| | 14 | — | 100 | — | — | — | — |
| | 15 | — | — | 100 | — | — | — |
| | 16 | — | — | — | 100 | — | — |
| | 17 | — | — | — | — | 100 | 100 |
| Spray coated on a TPO plate only | | TPO | TPO | Both | Both | TPO | Both |
| or both of a TPO plate and a decorative sheet | | only | only | | | only | |
| Other polymers | Shoprene (trademark) SD753 | — | — | — | — | | |
| Thickener | ADEKANOL UH-752 | | | | 0.10 | | |
| External | ADH | 0.93 | 0.93 | 0.93 | 0.93 | 0.43 | 0.43 |
| crosslinking agent | | | | | | | |
| Evaluation | Room Temp. | 8.5 | 12 | 11 | 10 | 9.5 | 19 |
| | Peeling strength | | | | | | |
| | (N/25 mm) | | | | | | |
| | Heat Resistance | 9.3 | 6.2 | 6.2 | 6.3 | 5.3 | 11 |
| | Peeling strength | | | | | | |
| | (N/25 mm) | | | | | | |
| | Heat Resistance | 10 | 5.0 | 0 | 0 | 0 | 0 |
| | 90 degree Creep | | | | | | |
| | (mm) | | | | | | |

It is clear to those skilled in the art that the embodiments and the examples described above can be varied in many ways without departing from the principle of the present invention. In addition, it is clear to those skilled in the art that the various modifications and changes of the present invention can be carried out without departing from the gist and the scope of the present invention.

### REFERENCE SIGNS LIST

100 Aqueous dispersant
101 (Meth)acrylate polymer particles
102 Particulate polymer
103 Solid-state chlorinated polyolefin particles

1. An aqueous adhesive composition comprising a particulate polymer containing a (meth)acrylate polymer and a chlorinated polyolefin.

2. The composition of claim 1, wherein the (meth)acrylate polymer is a polymer obtained from a material comprising an alkyl (meth)acrylate including an alkyl group having from 1 to 18 carbons, an unsaturated monomer including a polar group, and an oil soluble polymerization initiator.

3. The composition of claim 2, wherein the alkyl (meth)acrylate is an alkyl (meth)acrylate having Tg of a homopolymer being 20° C. or more and an alkyl (meth)acrylate being other than the alkyl (meth)acrylate and including an alkyl group having from 4 to 18 carbons.

4. The composition of claim 2, wherein the material further comprises an internal crosslinking agent.

5. The composition of claim 1, further containing an external crosslinking agent.

6. The composition of claim 1, wherein a chlorine content of the chlorinated polyolefin is in the range of 20 to 26 mass %.

7. The composition of claim 1, wherein an average particle size of the particulate polymer is in the range of 0.5 to 20 μm.

8. The of claim 1 used for spray coating.

9. A laminate comprising a base material and an adhesive layer obtained from the composition of claim 1.

10. A structure comprising a first adherend including a polyolefin resin, and a second adherend that are bonded to each other via an adhesive layer obtained from the composition of claim 1.

11. A method for producing an aqueous adhesive composition containing a particulate polymer, the method comprising:
compounding a chlorinated polyolefin in a (meth)acrylate monomer to prepare a solution,
mixing and suspending the solution and water containing a surfactant to prepare a suspension comprising droplets incorporating the (meth)acrylate monomer and a dissolved chlorinated polyolefin, and
compounding an oil soluble polymerization initiator in the suspension and then polymerizing the (meth)acrylate monomer to prepare a particulate polymer containing a (meth)acrylate polymer and a chlorinated polyolefin.
